(19) United States
(12) Patent Application Publication
(10) Pub. No.: US 2026/0330095 A1
(43) Pub. Date: Oct. 22, 2026

(54) AUTOMATIC CALIBRATION METHOD AND SYSTEM FOR A DEM SIMULATION MODEL BASED ON PARALLEL COMPUTING

(71) Applicant: Yangtze University, Jingzhou (CN)

(72) Inventors: Zhou Hu, Yueyang (CN); Tong Hu, Hanchuan (CN); Jinqiu Zhang, Xiangyang (CN); Meixia He, Jingzhou (CN)

(21) Appl. No.: 19/702,023

(22) Filed: Jun. 9, 2026

(30) Foreign Application Priority Data
Jun. 10, 2025 (CN) 202510764536.9

(51) Int. Cl. G06F 30/20

(52) U.S. Cl. CPC G06F 30/20

(57) ABSTRACT

This invention pertains to the field of simulation model calibration, providing an automatic calibration method for DEM (Discrete Element Method) simulation models based on parallel computing. The method involves establishing an intelligent model between the simulation macroscopic characteristics and physical macroscopic characteristics. The physical macroscopic characteristics are input into the established intelligent model to obtain the corresponding simulation microscopic parameters as initial values. These initial values undergo parallel simulations, data analysis, and comparisons. The simulation microscopic parameters corresponding to the smallest error in the simulation macroscopic characteristics are selected as the initial values for the next iteration. This cycle continues until the relative error between the simulation macroscopic characteristics and physical macroscopic characteristics is lower than the set threshold, or the calibration count reaches the upper limit, completing the calibration. Based on parallel computing, this invention can greatly improve the efficiency of calibrating simulation parameters.

### CROSS-REFERENCE TO RELATED APPLICATIONS

This application claims priority to Chinese Patent Application No. 202510764536.9, filed on Jun. 10, 2025, which is hereby incorporated by reference in its entirety.

### TECHNICAL FIELD

The invention relates to the field of simulation model calibration, specifically to an automatic calibration method for a DEM simulation model based on parallel computing.

### BACKGROUND

With the rapid development of China's economy, rotary kilns, dryers, coating machines, and other rotary drum equipment play a critical role in industries such as cement, metallurgy, and pharmaceuticals. The core functions of these devices, such as material mixing, drying, and coating, are crucial for improving product quality and production efficiency. However, due to the complex properties of granular materials, which combine both solid and fluid characteristics, the motion mechanism of materials inside the drum remains unclear.

With the rapid development of advanced computational technologies, the Discrete Element Method (DEM) has become an important tool for analyzing the complex physical processes of granular materials. By utilizing DEM, it is possible to simulate the motion and interaction of large numbers of particles under specific conditions, thus providing effective support for understanding and improving the material processing flow in rotary drum equipment. Through DEM simulation, researchers can explore the influence of key operational conditions and material characteristics on mixing efficiency without relying on actual production experiments. This greatly helps to avoid the high costs and economic losses associated with traditional experimental research.

To ensure the accuracy of DEM model simulation results, it is necessary to calibrate the model, i.e., by continuously adjusting the simulation input parameters so that the obtained simulation macroscopic characteristics match the macroscopic characteristics obtained from physical experiments. However, current calibration methods for DEM model parameters mostly rely on manual operations, which are tedious and inefficient process, and their accuracy are also difficult to guarantee. In our team's Chinese patent application number CN202310828095.5 for a “Particle Material Simulation Parameter Calibration Method, Device, Equipment, and Storage Medium,” a data-driven parameter calibration method was proposed. However, this method performs simulation for one parameter set at a time, obtains simulation macroscopic characteristics, and then matches them with physical experiment macroscopic characteristics. If the relative error is less than a set value, the calibration stops; otherwise, parameter adjustments are made, and the simulation is repeated until the stop condition is reached. However, this method usually requires multiple iterations of parameter tuning and simulation to complete the calibration of DEM model parameters, making it a serial parameter calibration method with efficiency that needs further improvement.

To address the current problem of low calibration efficiency for DEM models, a DEM simulation model automatic calibration method based on parallel computing is needed to significantly improve the efficiency of simulation parameter calibration.

### SUMMARY

The problem solved by the present invention is how to provide an automatic calibration method for a DEM simulation model based on parallel computing, which can significantly improve the calibration efficiency of simulation parameters.

To solve the above problem, the present invention provides an automatic calibration method for a DEM simulation model based on parallel computing, including: obtaining physical macroscopic characteristics, generating multiple sets of initial simulation microscopic parameters when the calibration count is count=0, performing parallel simulations and data processing on the multiple sets of initial simulation microscopic parameters, obtaining the simulation macroscopic characteristics corresponding to the initial simulation microscopic parameters, sending the multiple sets of simulation macroscopic characteristics and physical macroscopic characteristics into a comparison and optimization module to determine whether the relative error between the simulation macroscopic characteristics and the physical macroscopic characteristics is lower than the set threshold. If so, the calibration is completed; if no, based on the simulation data obtained from parallel simulations of the initial simulation microscopic parameters, an intelligent model is established between the simulation macroscopic characteristics and the physical macroscopic characteristics;

When the calibration count is count=1, the physical macroscopic characteristics are input into the constructed intelligent model to obtain the corresponding simulation microscopic parameters as initial values. Parallel simulations, data analysis, and comparisons are performed on the initial values, and the microscopic parameters corresponding to the simulation macroscopic characteristics with the smallest error are selected as the initial value for the next iteration. This process repeats until the relative error between the simulation macroscopic characteristics and the physical macroscopic characteristics in the current iteration is lower than the set threshold, or the calibration count reaches the set upper limit, at which point the calibration is completed.

Further, the step of obtaining physical macroscopic characteristics includes:

Acquiring images of the particle material movement process inside the rotary drum through a physical experiment module, sending them to a data processing and analysis module for filtering and binarization processing, extracting the repose angle data at different times, and using a second-order model to fit the acquired repose angle data to obtain the dynamic repose angle as the physical macroscopic characteristic.

Further, when the calibration count is count=0, generating multiple sets of initial simulation microscopic parameters, and performing parallel simulations and data processing on these multiple sets of initial simulation microscopic parameters includes:

Using the parallel simulation parameter generation module to generate input parameters between 0 and 1, with the step size being Δμ_{b}. The input parameters are

$${μ}_{b}^{( 1 )} , … , {μ}_{b}^{( k )} , {μ}_{b}^{( k + 1 )} , … , {μ}_{b}^{( n )} , where {μ}_{b}^{( 1 )} = {Δμ}_{b} , \\ {μ}_{b}^{( k + 1 )} = {μ}_{b}^{( k )} + {Δμ}_{b} ( k > 0 ) , {μ}_{b}^{( n )} = {Δμ}_{b} ( ⌈ \frac{1}{{Δμ}_{b}} ⌉ - 1 ) , n = ⌈ \frac{1}{{Δμ}_{b}} ⌉ - 1.$$

The corresponding simulation folders are then batch-created;
Using the DEM simulation module to perform parallel simulations and collect simulation data;
Sending the simulation data to the data processing and analysis module to obtain the simulation macroscopic characteristics corresponding to each input parameter.

Further, the step of establishing an intelligent model between the simulation macroscopic characteristics and the physical macroscopic characteristics includes:
Establishing a simulation database between the initial simulation microscopic parameters and their corresponding simulation macroscopic characteristics;
Performing data preprocessing, removing outliers, and organizing the data;

Using the least squares method as the core fitting algorithm and polynomial functions as the fitting model to construct an intelligent model between simulation macroscopic characteristics and physical macroscopic characteristics.

Further, the step of removing outliers includes using a moving average method to obtain the smoothed value of the simulation macroscopic characteristics from the simulation output, and determining whether the distance between the simulation macroscopic characteristics and the smoothed value for each group of simulation data is greater than the set value. If so, that set of simulation data is removed; otherwise, it is retained.

Further, the step of data organization includes rearranging the simulation data after outlier removal, with simulation macroscopic characteristics as input and simulation microscopic parameters as output.

Further, the step of performing parallel simulations, data analysis, and comparison for the initial value includes:

Taking the initial value of the current iteration which is μ_{b0}), using μ_{b0} as the center and a step size of Δμ_{b}, generating equally spaced microscopic parameters to be simulated:

$${μ}_{b}^{( 1 )} , … , {μ}_{b}^{( i )} , … , {μ}_{b}^{( k + 1 )} , … , {μ}_{b}^{( n )} , where : {μ}_{b}^{( k + 1 )} = {μ}_{b 0} , \\ {μ}_{b}^{( i )} = {μ}_{b 0} + ( i - k - 1 ) {Δμ}_{b} ( i = 1 , … , n ) , n = 2 k + 1 ;$$

Batch-creating the corresponding simulation folders based on the microscopic parameters to be simulated;
Using the microscopic parameters to be simulated, performing parallel DEM simulations, and generating simulation data;
Inputting the simulation data into the data processing and analysis module to obtain the macroscopic characteristics of each simulation in the current iteration;
Determining whether the relative error between the simulation macroscopic characteristic and the physical macroscopic characteristic in the current iteration is lower than the set threshold. If so, ending the calibration; if no, selecting the microscopic parameter corresponding to the simulation macroscopic characteristic with the smallest error as the initial value for the next iteration.

Further, the step of performing parallel DEM simulations includes:

Opening n DEM simulation software interfaces, where each interface runs the corresponding DEM simulation code for the microscopic parameters

$${μ}_{b}^{( 1 )} , … , {μ}_{b}^{( n )}$$

to be simulated; and storing the corresponding simulation data, images, and other relevant parameters.

Further, when the calibration is completed, if the termination condition for calibration is that the relative error between the simulation macroscopic characteristic and the physical macroscopic characteristic in the current iteration is lower than the set threshold, the microscopic parameter corresponding to the smallest relative error is selected as the final calibration value. If the termination condition for calibration is that the calibration count reaches the set upper limit, the microscopic parameter corresponding to the smallest relative error among all iterations is selected as the final calibration value.

The present invention also provides an automatic calibration system for a DEM simulation model based on parallel computing, used to execute the automatic calibration method for a DEM simulation model based on parallel computing described above, comprising:
A physical experiment module, used to acquire physical experimental data;
A data processing and analysis module, used to acquire physical macroscopic characteristics from the physical experimental data, acquire simulation macroscopic characteristics from the simulation data, and construct an intelligent model;
A parallel simulation parameter generation module, used to generate corresponding simulation microscopic parameters based on the calibration count;
A DEM simulation module, used to perform parallel DEM simulation processing on the multiple sets of simulation microscopic parameters generated by the parallel simulation parameter generation module;
A comparison and optimization module, used to determine the completion status of the calibration and output the final calibration value.

Compared with the prior art, the present invention has the following beneficial effects:

The present invention generates multiple sets of equally spaced simulation microscopic parameters initially, performs parallel simulations, and establishes an intelligent model. Furthermore, in subsequent calibrations, the initial value for the current iteration is used as the center, and multiple sets of simulation parameters are generated with the same step size. Parallel simulations, data processing, and comparisons are performed in a loop to output the final calibration value. Through this parallel data processing method, the invention effectively addresses the cumbersome, complex, and time-consuming issues of traditional calibration methods.

### BRIEF DESCRIPTION OF THE DRAWINGS

FIG. 1 is a schematic diagram of the overall principle structure of the present invention;

FIG. 2. is a table of physical parameters for parallel simulation in an embodiment of the present invention;

FIG. 3 is a table of simulation database for the first embodiment of the present invention when the calibration count is 0;

FIG. 4 is a table comparing the simulation database of the intelligent model and the physical experimental results in the first embodiment of the present invention;

FIG. 5 is a table of the intelligent model simulation database in the first embodiment of the present invention;

FIG. 6 is a schematic diagram of the fitting results of the intelligent model in the first embodiment of the present invention;

FIG. 7 is a table of parallel simulation parameters when the calibration count is 1 in the first embodiment of the present invention;

FIG. 8 is a table of simulation macroscopic parameters when the calibration count is 1 in the first embodiment of the present invention;

FIG. 9 is a table comparing the parallel simulation results and the physical experimental results when the calibration count is 1 in the first embodiment of the present invention;

FIG. 10 is a table of the simulation database in the second embodiment of the present invention;

FIG. 11 is a table comparing the parallel simulation results and the physical experimental results in the second embodiment of the present invention.

### DESCRIPTION OF EMBODIMENTS

To make the above objectives, characteristics, and advantages of the present invention more apparent and understandable, the following detailed description of specific embodiments of the present invention is provided in conjunction with the accompanying

### DRAWINGS

In the description of the present invention, it should be noted that unless otherwise specified and defined, the terms “set,” “install,” “connected,” and “coupled” should be broadly understood. For example, these terms may refer to fixed connections, detachable connections, or integrated connections; they may refer to mechanical connections; they may refer to direct connections, or connections through an intermediate medium; they may refer to internal communication between two elements. The specific meaning of these terms in the present invention can be understood according to the specific situation by those skilled in the art.

In the description of this specification, the terms “embodiment,” “an embodiment,” and “a mode” refer to the specific characteristics, structures, materials, or characteristics described in conjunction with that embodiment or mode, which are included in at least one embodiment or mode of the present invention. In this specification, the use of these terms does not necessarily refer to the same embodiment or mode. Moreover, the specific characteristics, structures, materials, or characteristics described can be combined in any suitable way in one or more embodiments or modes.

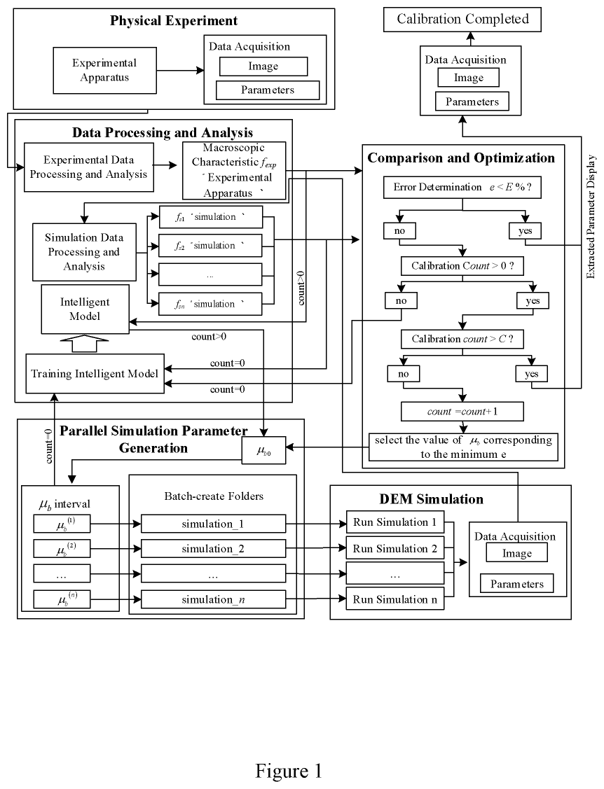

As shown in FIG. 1, the present invention provides an automatic calibration system for a DEM simulation model based on parallel computing, which mainly includes five modules: physical experiments, data processing and analysis, parallel simulation parameter generation, DEM simulation, and comparison and optimization. The main steps of the automatic calibration method are as follows:

Step 1: Use the physical experiment device to acquire experimental data, images, and other related parameters for the calibration object, and perform experimental data processing and analysis to obtain the physical experimental macroscopic characteristic fₑₓₚ.

Step 2: When the calibration count is count=0, Using the parallel simulation parameter generation module to generate input parameters between 0 and 1, with the step size being Δμ_{b}. The input parameters are

$${μ}_{b}^{( 1 )} , … , {μ}_{b}^{( k )} , {μ}_{b}^{( k + 1 )} , … , {μ}_{b}^{( n )} , where {μ}_{b}^{( 1 )} = {Δμ}_{b} , \\ {μ}_{b}^{( k + 1 )} = {μ}_{b}^{( k )} + {Δμ}_{b} ( k > 0 ) , {μ}_{b}^{( n )} = {Δμ}_{b} ( ⌈ \frac{1}{{Δμ}_{b}} ⌉ - 1 ) , n = ⌈ \frac{1}{{Δμ}_{b}} ⌉ - 1.$$

The corresponding simulation folders are then batch-created;
Then, use the DEM simulation module to perform parallel simulations, collect simulation data; send the data to the data processing and analysis module to obtain the macroscopic characteristics fs1, fs2, . . . , fsn for each simulation; send the simulation macroscopic characteristics and the physical experimental macroscopic characteristics fₑₓₚ obtained in Step 1 to the comparison and optimization module, and determine whether the relative error between the simulation macroscopic characteristic and the physical macroscopic characteristic is lower than the set threshold E. If the relative error is smaller than the set threshold, end the calibration and output the microscopic parameter corresponding to the smallest relative error as the calibration value. Otherwise, based on the simulation data obtained when count=0, establish an intelligent model between the dynamic repose angle and the friction coefficient, and continue the calibration according to Steps 2 to 5.

If count=1, the obtained physical macroscopic characteristic fₑₓₚ is input into the constructed intelligent model to predict the corresponding initial simulation microscopic parameter μ_{b0}; otherwise, continue.

Use this initial value μ_{b0} as input and send it to the parallel simulation parameter generation module. This module, with μ_{b0} as the center and a step size of Δμ_{b}, generates equally spaced microscopic parameters to be simulated:

$${μ}_{b}^{( 1 )} , … , {μ}_{b}^{( i )} , … , {μ}_{b}^{( k + 1 )} , … , {μ}_{b}^{( n )} , where : {μ}_{b}^{( k + 1 )} = {μ}_{b 0} , \\ {μ}_{b}^{( i )} = {μ}_{b 0} + ( i - k - 1 ) {Δμ}_{b} ( i = 1 , … , n ) , n = 2 k + 1 ;$$

Based on the generated simulation parameters, batch-create the corresponding simulation folders, which contain the main program code required for the simulation and folders to store the simulation data.

Step 3: Using the simulation parameters generated in Step 2, perform parallel DEM simulations, that is, the calibration platform opens n DEM simulation software interfaces, where each interface runs the corresponding DEM simulation code for the microscopic parameters

$${μ}_{b}^{( 1 )} , {μ}_{b}^{( 2 )} , … , {μ}_{b}^{( n )}$$

to be simulated; and stores the corresponding simulation data, images, and other relevant parameters.

Step 4: Input the simulation data generated in Step 3 into the data processing and analysis module to extract the macroscopic characteristics of each simulation.

Step 5: Send the simulation macroscopic characteristics fs1, fs2, . . . , fsn obtained in Step 4 and the physical macroscopic characteristics fexp obtained in Step 1 to the comparison and optimization module. Determine whether the relative error between the simulation macroscopic characteristic and the physical macroscopic characteristic in the current iteration is lower than the set threshold E. If the minimum relative error is smaller than E, select the microscopic parameter corresponding to the minimum relative error as the final calibration value and terminate the calibration process. If the minimum relative error in the current iteration is still greater than E, determine whether the calibration count count has reached the set upper limit C. If so, terminate the calibration and select the microscopic parameter with the smallest error among all iterations as the final calibration value. Otherwise, use the microscopic parameter corresponding to the minimum relative error as the new initial value, and repeat Step 2 to Step 5 to continue the calibration.

This process will iterate until any of the following stop conditions is met: the relative error e is less than the set threshold E, or the calibration count count reaches the set upper limit C. The final calibration value is the microscopic parameter with the smallest error. The above steps are repeated until the stop condition is met, completing the model calibration.

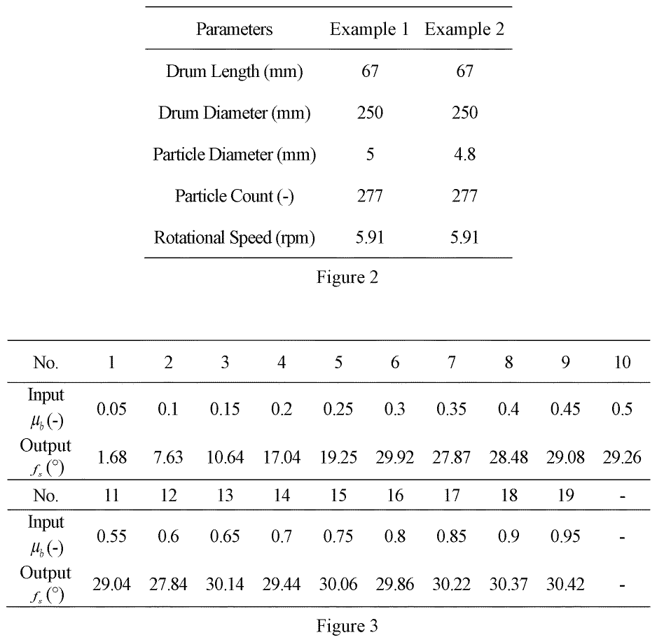

Further, two embodiments with different particle sizes are selected for detailed explanation, as shown in FIG. 2. In the embodiment, the rotary drum has a length of 67 mm, a diameter of 250 mm, and a speed of 5.91 rpm. The granular material is acrylic spherical particles, with the microscopic parameter being the friction coefficient μ_{b} of the granular material, and the macroscopic characteristic used is the dynamic repose angle f.

### Example 1

The first phase: First, images of the movement of the granular material inside the rotary drum are captured by the physical experiment module, and sent to the data processing and analysis module for processing, including filtering, binarization, etc., to extract repose angle data at different time points. Then, a second-order model is used to fit the acquired repose angle data to obtain the dynamic repose angle fₑₓₚ15.4°.

The second phase: At this point, count=0, use the parallel simulation parameter generation module to generate a step size of Δμ_{b}=0.05 n=19, 19 sets of equally spaced friction coefficients between 0 and 1, and the corresponding simulation folders, as shown in FIG. 3, and perform parallel simulations using the DEM simulation module.

### 1) Extraction of Macroscopic Characteristics:

The images from the 19 simulations are processed and analyzed, and the steps are the same as those used for extracting physical macroscopic characteristics. A simulation database is created between the input microscopic parameters (friction coefficient μ_{b}) and the output macroscopic characteristics (dynamic repose angle fₛ), as shown in FIG. 3.

The relative error between the simulated dynamic repose angle and the physical dynamic repose angle fₑₓₚ is calculated using the formula:

$$e = \vert \frac{{f}_{e xp} - {f}_{s}}{{f}_{e xp}} \vert \times 100 \% ,$$

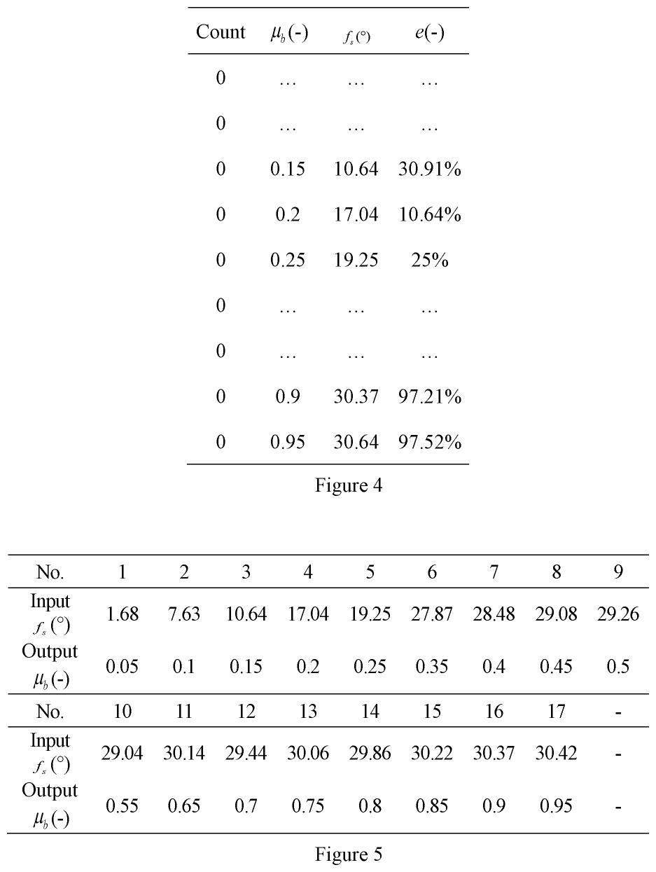

Partial results are shown in FIG. 4. The relative error e did not fall below the set threshold of 5%, with the minimum relative error being e=10.64%, which does not meet the condition to end the calibration.

### 2) Data Preprocessing:

a) Outlier Removal: First, a 5-point moving average smoothing filter is used to process the dynamic repose angle during the stable state of the simulation output. Then, it is determined whether the distance between the simulation output dynamic repose angle and the smoothed value is greater than the set value H (in this example, H=1′). If so, the corresponding set of simulation data is removed to ensure the reliability of the modeling data; otherwise, it is retained. For example, in this case, the dynamic repose angle and the smoothed value of the 6th simulation in FIG. 3 are 29.92° and 24.512°, respectively, and the distance between the two values is greater than 1°. Similarly, the dynamic repose angle and the smoothed value of the 12th simulation are 27.84° and 29.144°, respectively, and the distance between these values is greater than 1°. Therefore, these two sets of data are excluded.

b) Data Organization: The data after outlier removal is rearranged, with macroscopic characteristics fₛ as inputs and microscopic parameters μ_{b} as outputs, used to build the intelligent model, as shown in FIG. 5.

This embodiment uses the Least Squares Method (LSM) as the core fitting algorithm and polynomial functions as the fitting model to construct an intelligent model between the dynamic repose angle fₛ and the friction coefficient μ_{b} of the particles. The simulation database used for modeling is shown in FIG. 5.

Polynomial models can choose different degrees. To ensure that the fitting results have both high accuracy and avoid negative values, the polynomial degree that performs optimally in both aspects was ultimately selected.

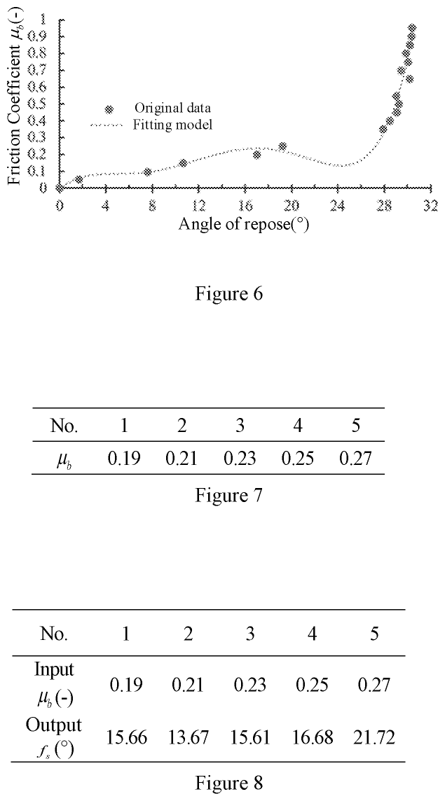

The fitting results are shown in FIG. 6, and its mathematical expression is:

μ_{b}=0.0000012656fₛ⁵−0.0000805962fₛ⁴+0.0017596225fₛ³−0.0156296032fₛ²+0.0617626772fₛ

The third phase: count=1, the physical repose angle fₑₓₚ=15.4° obtained by the physical experiment module is input into the intelligent model to predict the initial value of the simulation microscopic parameter μ_{b}=0.23. Using the parallel simulation parameter generation module, with μ_{b}=0.23 as the center and Δμ_{b}=0.02 as the step size, the method described in the third phase is used to generate 5 simulation input friction coefficients (n=5), as shown in FIG. 7.

To automate the execution of this algorithm, the DEM simulation parameter generation module was built on the Lab VIEW platform. This module can automatically create the corresponding number of simulation directories simulation_i (i=1, . . . , n, n=5) based on the initial friction coefficient, step size, and n. Each directory contains the necessary input files and script codes for running the corresponding DEM simulation, such as the main program main.dat, subprogram functions function.dat, etc., and has independent running capability.

The fourth phase: The calibration platform opens 5 DEM simulation software interfaces simultaneously and runs the main program main.dat from the generated simulation directories simulation_1, simulation_2, . . . for each simulation.

The fifth phase: The simulation images and particle information obtained are then transferred via the LabVIEW automation platform to the MATLAB environment, where further image processing and characteristic extraction operations are performed to recognize and extract the dynamic repose angle as the macroscopic characteristic of the simulation.

The simulation images from the 5 simulations are processed and analyzed to obtain the corresponding simulation repose angle data, as shown in FIG. 8.

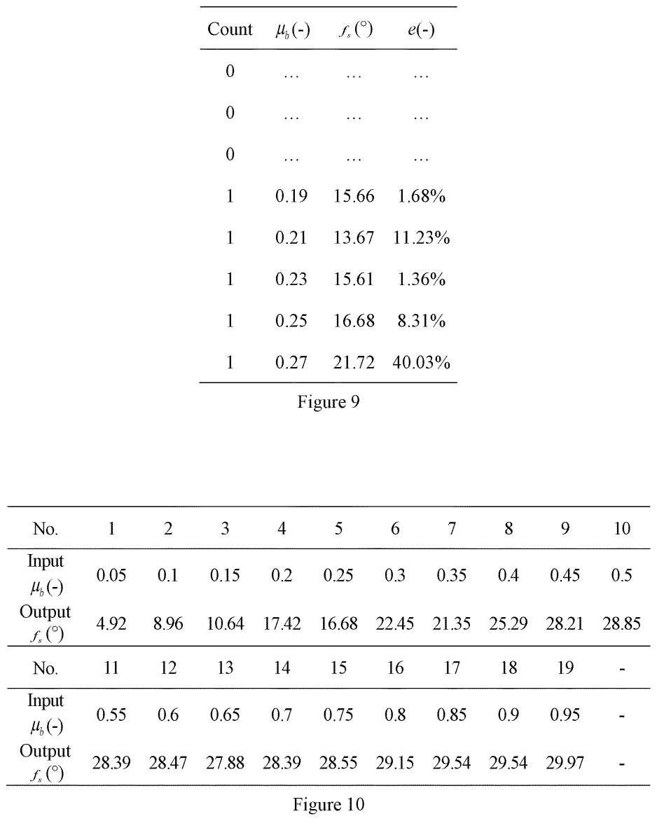

The sixth phase: The relative error between the simulated dynamic repose angle and the physical dynamic repose angle fₑₓₚ=15.4° is calculated, as shown in FIG. 9.

As shown in FIG. 9, when the simulated friction coefficients are 0.19 and 0.23, the calculated relative errors are both below the set threshold of 5%, so the calibration process ends here. After comparison, the friction coefficient of 0.23 gives the smallest relative error, so μ_{b}=0.23 is selected as the final calibration value.

### Example 2

The first phase: Use the physical experiment module and data processing and fₑₓₚ=29.24ª analysis module to acquire the dynamic repose angle for the granular material with a particle diameter of 4.8 mm in Example 2.

The second phase: At this point, count=0, use the parallel simulation parameter generation module to generate parallel simulation parameters (the variable being the friction coefficient μ_{b}) and the corresponding simulation folders; and use the DEM simulation module to perform parallel simulations; then, send the simulation data to the data processing and analysis module to obtain the macroscopic characteristics (dynamic repose angle fₛ) for each simulation, as shown in FIG. 10.

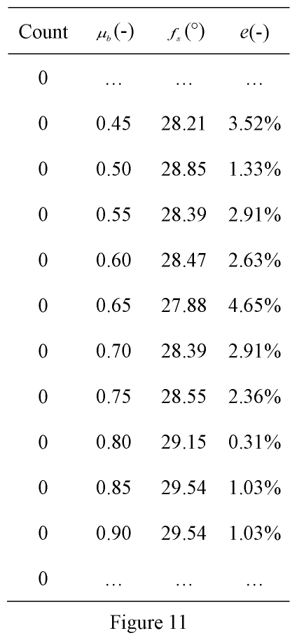

The relative error between the dynamic repose angle fₛ for each simulation and the physical dynamic repose angle fₑₓₚ is calculated, as shown in FIG. 11.

As shown in FIG. 11, multiple sets of simulations have a relative error between the dynamic repose angle and the physical dynamic repose angle less than the set threshold of 5%, so the calibration process is terminated, and the friction coefficient which is 0.80 corresponding to the minimum relative error of 0.31% is selected as the calibration value.

Although the disclosure has been described above, the scope of protection of this disclosure is not limited to this. Those skilled in the art may make various changes and modifications without departing from the spirit and scope of the disclosure, and such changes and modifications will fall within the scope of protection of the present invention.

What is claimed is:

1. An automatic calibration method for DEM simulation models based on parallel computing, characterized by the following steps:
Obtaining physical macroscopic characteristics. When the calibration count is 0, multiple sets of initial simulation microscopic parameters are generated. These sets undergo parallel simulation and data processing to obtain the corresponding simulation macroscopic characteristics. The simulation macroscopic characteristics and physical macroscopic characteristics are then input into a comparison and selection module to check whether the relative error between the simulation macroscopic characteristics and physical macroscopic characteristics is below the set threshold. If so, the calibration is complete. If not, an intelligent model is established between the simulation macroscopic characteristics and physical macroscopic characteristics based on the simulation data from the initial simulation microscopic parameters;
When the calibration count is 1, the physical macroscopic characteristics are input into the established intelligent model, and the corresponding simulation microscopic parameters are obtained as initial values. These values undergo parallel simulation, data analysis, and comparison to obtain the simulation microscopic parameters corresponding to the simulation macroscopic characteristics with the smallest error. This process continues until the relative error is below the set threshold or the calibration count reaches the upper limit, completing the calibration.

2. The automatic calibration method for a DEM simulation model based on parallel computing according to claim 1, characterized in that the step of obtaining physical macroscopic characteristics includes:
Using a physical experimental module to collect images of the movement of particulate material inside a rotary drum. The images are then sent to the data processing and analysis module for filtering and binarization, extracting the repose angle data at different times, and fitting the obtained repose angle data using a second-order model to obtain the dynamic repose angle, which serves as the physical macroscopic characteristic.

3. The automatic calibration method for a DEM simulation model based on parallel computing according to claim 1, characterized in that, when the calibration count is count=0, generating multiple sets of initial simulation microscopic parameters, and performing parallel simulations and data processing on the multiple sets of initial simulation microscopic parameters includes:
Using the parallel simulation parameter generation module to produce parameters ranging from 0 to 1, with the step size being Δμ_{b}. The input parameters are
$${μ}_{b}^{( 1 )} , … , {μ}_{b}^{( k )} , {μ}_{b}^{( k + 1 )} , … , {μ}_{b}^{( n )} , where {μ}_{b}^{( 1 )} = {Δμ}_{b} , \\ {μ}_{b}^{( k + 1 )} = {μ}_{b}^{( k )} + {Δμ}_{b} ( k > 0 ) , {μ}_{b}^{( n )} = {Δμ}_{b} ( ⌈ \frac{1}{{Δμ}_{b}} ⌉ - 1 ) , n = ⌈ \frac{1}{{Δμ}_{b}} ⌉ - 1.$$
The corresponding simulation folders are then batch-created;
Using the DEM simulation module to perform parallel simulations, collecting the simulation data;
Sending the simulation data to the data processing and analysis module to obtain the simulation macroscopic characteristics corresponding to each input parameter.

4. The automatic calibration method for a DEM simulation model based on parallel computing according to claim 1, characterized in that the step of establishing an intelligent model between simulation macroscopic characteristics and physical macroscopic characteristics includes:
Establishing a simulation database between the initial simulation microscopic parameters and their corresponding simulation macroscopic characteristics;
Performing data preprocessing, removing outliers, and organizing the data;
Using the least squares method as the core fitting algorithm and polynomial functions as the fitting model to build the intelligent model between the simulation macroscopic characteristics and physical macroscopic characteristics.

5. The automatic calibration method for a DEM simulation model based on parallel computing according to claim 4, characterized in that the step of removing outliers includes using a moving average method to obtain the smoothed value of the simulation macroscopic characteristics from the simulation output, and judging whether the distance between the simulation macroscopic characteristics and the smoothed value for each group of simulation data is greater than a set value. If so, that set of simulation data is removed; otherwise, it is retained.

6. The automatic calibration method for a DEM simulation model based on parallel computing according to claim 5, characterized in that the step of data organization includes rearranging the simulation data after outlier removal, using the simulation macroscopic characteristics as input and the simulation microscopic parameters as output.

7. The automatic calibration method for a DEM simulation model based on parallel computing according to claim 1, characterized in that the step of performing parallel simulations, data analysis, and comparison on the initial values includes:
Taking the initial value of the current iteration which is μ_{b0}), using μ_{b0} as the center and a step size of Δμ_{b}, generating equally spaced microscopic parameters to be simulated:
$${μ}_{b}^{( 1 )} , … , {μ}_{b}^{( i )} , … , {μ}_{b}^{( k + 1 )} , … , {μ}_{b}^{( n )} , where : {μ}_{b}^{( k + 1 )} = {μ}_{b 0} , \\ {μ}_{b}^{( i )} = {μ}_{b 0} + ( i - k - 1 ) {Δμ}_{b} ( i = 1 , … , n ) , n = 2 k + 1 ;$$
Batch-creating corresponding simulation folders based on the microscopic parameters to be simulated;
Using the microscopic parameters to be simulated, executing DEM simulations and generating simulation data;
Inputting the simulation data into the data processing and analysis module to obtain the macroscopic characteristics of each simulation in the current iteration;
Determining whether the relative error between the simulation macroscopic characteristic and the physical macroscopic characteristic is lower than the set threshold, if so, ending the calibration; if not, selecting the microscopic parameter corresponding to the simulated macroscopic characteristic with the minimum error as the initial value for the next iteration.

8. The automatic calibration method for a DEM simulation model based on parallel computing according to claim 7, characterized in that the step of performing parallel DEM simulations includes:
Opening n DEM simulation software interfaces, where each interface runs the corresponding DEM simulation code for the microscopic parameters μ_{b}⁽¹⁾, . . . , μ_{b}⁽ⁿ⁾ to be simulated; and storing the corresponding simulation data, images, and other relevant parameters.

9. The automatic calibration method for a DEM simulation model based on parallel computing according to claim 1, characterized in that, when the calibration is completed, if the termination condition for calibration is that the relative error between the simulation macroscopic characteristic and the physical macroscopic characteristic in the current iteration is lower than the set threshold, the microscopic parameter corresponding to the smallest relative error is selected as the final calibration value. If the termination condition for calibration is that the calibration count reaches the set upper limit, the microscopic parameter corresponding to the smallest relative error among all iterations is selected as the final calibration value.

10. An automatic calibration system for a DEM simulation model based on parallel computing, used to execute the automatic calibration method for a DEM simulation model based on parallel computing as described claim 1, characterized by comprising:
A physical experiment module, used to acquire physical experimental data;
A data processing and analysis module, used to acquire physical macroscopic characteristics from the physical experimental data, acquire simulation macroscopic characteristics from the simulation data, and construct an intelligent model;
A parallel simulation parameter generation module, used to generate corresponding simulation microscopic parameters based on the calibration count;
A DEM simulation module, used to perform parallel DEM simulation processing on the multiple sets of simulation microscopic parameters generated by the parallel simulation parameter generation module;
A comparison and optimization module, used to determine the completion status of the calibration and output the final calibration value.
